(19) United States
(12) Patent Application Publication
(10) Pub. No.: US 2007/0224927 A1
(43) Pub. Date: Sep. 27, 2007

(54) Coin Sorting Apparatus

(75) Inventor: Jong S. Lee, Gyounggi-Do (KR)

Correspondence Address: CONNOLLY BOVE LODGE & HUTZ LLP, 1875 EYE STREET, N.W., SUITE 1100, WASHINGTON, DC, 20036, US

(73) Assignee: MIRTECH CO., LTD., Busan (KR)

(21) Appl. No.: 11/688,411

(22) Filed: Mar. 20, 2007

(30) Foreign Application Priority Data
Mar. 22, 2006 (KR) 10-2006-0025997

(51) Int. Cl. G07D 3/00; G07D 9/00; G07D 9/06; G07D 9/04

(52) U.S. Cl. 453/9; 453/61; 453/58

(57) ABSTRACT

A coin sorting apparatus is provided. The coin sorting apparatus includes a main body, a coin sorting unit, a transport unit, a casing tube, a coin tube, and a pressing unit. The coin sorting unit is disposed in an upper portion of the main body. The transport unit is disposed in a lower portion of the main body. The casing tube is transported by the transport unit. The coin tube is made of transparent plastic and placed within the casing tube. The pressing unit is disposed in a front portion of the main body. The present invention makes it possible to improve a functionality and usability of the coin sorting apparatus.

### BACKGROUND OF THE INVENTION

1. Field of the Invention

The present invention relates to a coin sorting apparatus, and more particularly, to a coin sorting apparatus capable of sorting and firmly packaging various coins easily and quickly.

2. Description of the Related Art

A related art coin sorting apparatus includes a main body, a coin sorting unit disposed in an upper portion of the main body, a transport unit disposed in a lower portion of the main body, a casing tube transported by the transport unit, and a coin tube placed within the casing tube.

However, the related art coin sorting apparatus provides a coin tube with its cover open, and thus needs an additional covering process.

Further, the coin tube of the related art coin sorting apparatus is made of paper. Accordingly, it is difficult to package coins firmly, and it is also difficult to see with the naked eye whether coins are properly contained in the coin tube.

This results in reduction of functionality and usability of the coin sorting apparatus.

### SUMMARY OF THE INVENTION

Accordingly, the present invention is directed to a coin sorting apparatus that substantially obviates one or more problems due to limitations and disadvantages of the related art.

An object of the present invention is to provide a coin sorting apparatus capable of sorting various coins and firmly packaging the sorted coins.

Another object of the present invention is to provide a coin sorting apparatus allowing packed coins to be visible to the naked eye.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a coin sorting apparatus including a main body; a coin sorting unit disposed in an upper portion of the main body to sort coins by type and drops the sorted coins; a transport unit disposed in a lower portion of the main body; a casing tube transported by the transport unit; a coin tube of transparent plastic, the coin tube being placed within the casing tube, and a top portion of the coin tube protruding from the casing tube and being open so that coins dropped from a coin sorting unit may be received and stacked in the coin tube; and a pressing unit disposed in a front portion of the main body to move up and down so as to press and bend inwardly a top portion of the coin tube in which coins are received and stacked.

Preferably, the pressing unit includes a driving part; a moving part coupled to the driving part to be moved up and down by the driving part; and a pressing part disposed under the moving part to press and bend an open top portion of the coin tube as the moving part moves down.

Preferably, the driving unit includes a motor; a pinion rotated by the motor; and a rack engaged with the pinion to move up and down through the rotation of the pinion.

Preferably, the coin sorting unit includes a first sensor for detecting how many coins are dropped into the coin tube and the pressing unit includes a second sensor for detecting a received state of the coins received and stacked in the coin tube.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a coin sorting apparatus according to the present invention;

FIG. 2 is a sectional view illustrating a coin sorting apparatus according to the present invention;

FIG. 3 is a schematic view illustrating a coin tube of a coin sorting apparatus according to the present invention;

FIG. 4 is a sectional view illustrating a pressing unit of a coin sorting apparatus according to the present invention; and

FIGS. 5A, 5B, 5C is a sectional view illustrating a series of processes for sorting and firmly packaging coins using a coin sorting apparatus according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

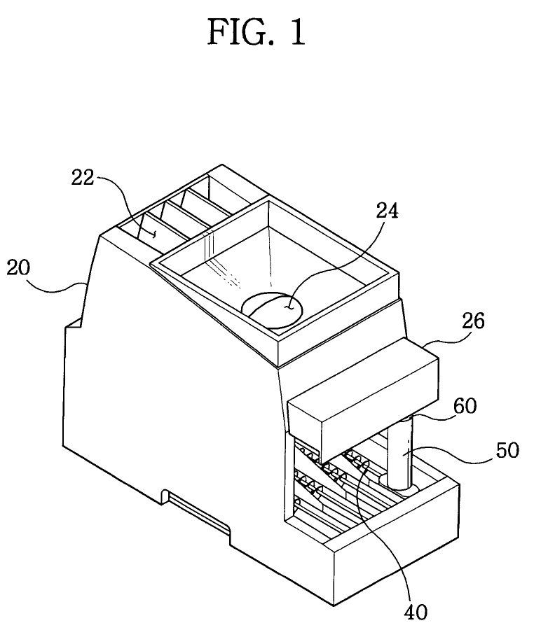

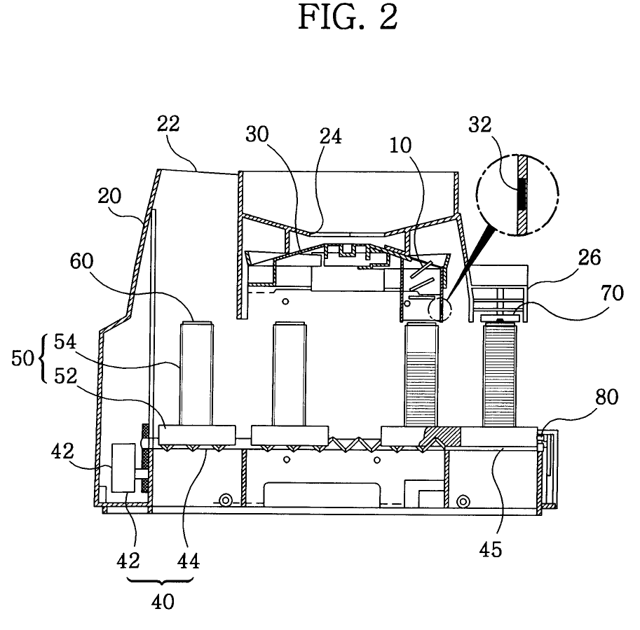

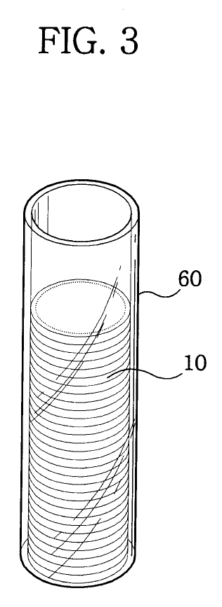

Referring to FIGS. 1 to 3, a coin sorting apparatus according to the present invention includes a main body 20, a coin sorting unit 30 disposed in an upper portion of the main body 20, a transport unit 40 disposed in a lower portion of the main body 20, a casing tube 50 transported by the transport unit 40, a coin tube 60 placed within the casing tube 50, and a pressing unit 70 disposed in a front portion of the main body 20 to move up and down.

A plurality of tube insert holes 22 are formed in a line in a rear portion of the main body 20 to stably seat the casing tubes 50 on the transport unit 40. A coin collecting hole 24 is formed in an upper portion of the main body 20 to allow coins to be input into the coin sorting unit 30.

A support bracket 26 is disposed in a front portion of the main body 20 to support the pressing unit 70.

The coin sorting unit 30 sorts coins by type through rotation and drops the sorted coins 10 into the coin tube 60.

For example, in the case of sorting the most common circulating coins of the United States of America, the coin sorting unit 30 sorts coins into four classes of 1 cent, 5 cents, 10 cents and 20 cents, and drops the same into the coin tube 60.

In addition, the coin sorting unit 30 includes a first sensor 32 to detect the number of coins 10 dropped into the coin tube 60 placed within the casing tube 50. With the first sensor 32, the number of coins 10 dropped into the coin tube 60 can be controlled accurately.

The first sensor 32 can be disposed at such a position as to easily detect the number of coins 10 dropped into the coin tube 60.

Any well-known coin sorting unit can be used as the coin sorting unit 30.

The transport unit 40 transports the casing tube 50 so that it is located under the coin sorting unit 30 and then under the pressing unit 70.

The transport unit 40 includes a motor 42 and a transport screw 44 which is rotated by the motor 42 to transport the casing tube 50. The operation of the transport unit 40 is controlled by a controller (not shown).

The transport screw 44 includes, at an end thereof, a straight portion 45 that is not spiraled. A casing tube 50 is transported to the straight portion 45 of the transport screw 44 through rotation of the transport screw 44. Then, the casing tube 50 is pushed further by following casing tube and located under the pressing unit 70.

The above-described transport unit 40 is only mentioned as an example. Any transport unit, such as a belt, can be used as the transport unit 40 as far as it can transport the casing tube 50 stably.

The casing tube 50 includes a seat 52 seated on the transport unit 40 and a long tube receiving part 54. The long tube receiving part 54 is integrally formed upright on the seat 52 to receive the coin tube 60.

The casing tube 50 is inserted through a tube insert hole 22 of the main body 20 so that it can be seated on the transport unit 40. Preferably, the casing tube 50 is made of transparent plastic.

The top of the coin tube 60 is open so that coins 10 are dropped into the coin tube 60 and stacked therein while the coin tube 60 is located under the coin sorting unit 30.

Preferably, the coin tube 60 is made of transparent material. More preferably, the coin tube 60 is made of transparent thermoplastic plastic.

In that case, by virtue of the characteristics of the transparent thermoplastic plastic, it is possible to stably maintain coins 10 firmly packaged in the coin tube 60. In addition, it is also possible to see if coins 10 of the same sort are packaged in the coin tube 60, so as to prevent an error caused by malfunction of the coin sorting unit 30.

The coin tube 60 protrudes upward from the casing tube 50 so that the protruding portion can be bent by the pressing unit 70.

In detail, the pressing unit 70 presses the top portion of the coin tube 60, which coins 10 are received and stacked in, so as to bend the protruding portion of the coin tube 60 inwardly. Accordingly, the open top portion of the coin tube 60 can be easily closed, so as to efficiently prevent the coins 10 received and stacked in the coin tube 60 from leaving out of the coin tube 60.

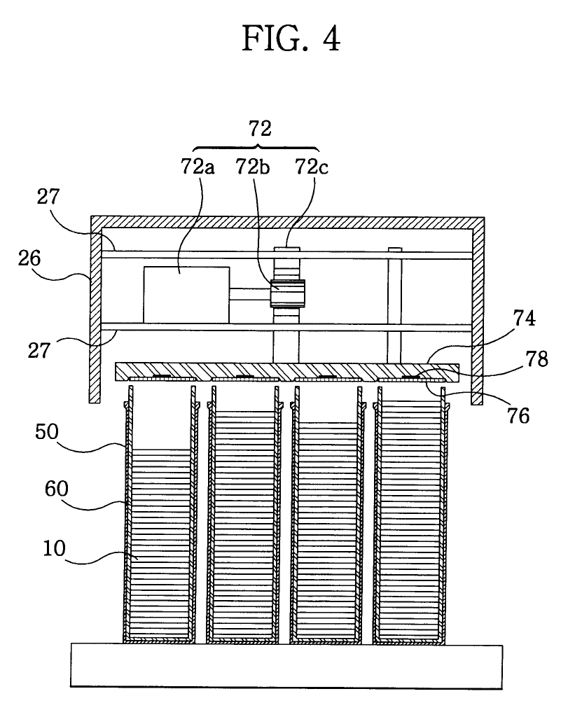

Referring to FIG. 4, the pressing unit 70 includes a driving part 72, a moving part 74 coupled to the driving part 72 to be moved up and down by the driving part 72, and a pressing part 76 disposed under the moving part 74. The pressing part 76 thermally presses an open top portion of the coin tube 60 placed within the casing tube 50 as the moving part 74 moves down.

The driving part 72 is supported stably by a pair of supports 27, which is disposed inside a support bracket 26.

The driving part 72 includes a motor 72a, a pinion 72b rotated by the motor 72a, and a rack 72c engaged with the pinion 72b to move up and down through the rotation of the pinion 72b.

Any well-known driving part, such as a cylindrical actuator, can be used as the driving part 72.

The moving part 74 includes a second sensor 78 to detect a received state of the coins 10 received and stacked in the coin tube 60. The second sensor 78 detects whether a predetermined number of coins 10 are received in the coin tube 60. Then, the pressing unit 70 operates when the predetermined number of coins 10 are received in the coin tube 60.

There are as many pressing parts 76 as the number of the tube insert holes 22 of the main body 20. Any pressing part, such as a hot plate emitting heat electrically, can be used as the pressing part 76 as far as it can bend the top portion of the coin tube 60 using thermal pressing.

The size and shape of the pressing part 76 can be appropriately controlled depending on the size of the coin tube 60.

A stop switch 80 is disposed at a front lower portion of the main body 20. When the casing tube 50 is located exactly under the pressing unit 70 by the transport unit 40, it contacts the stop switch 80, so that an operation of the transport unit 40 halts temporarily.

In other words, the transport unit 40 stops operation when the casing tube 50 contacts the stop switch 80, so that bending the coin tube 60 is performed accurately by the pressing unit 70. When the pressing unit 70 completes the bending, the casing tube 50 is separated from the transport unit 40, so that the transport unit 40 starts to operate again.

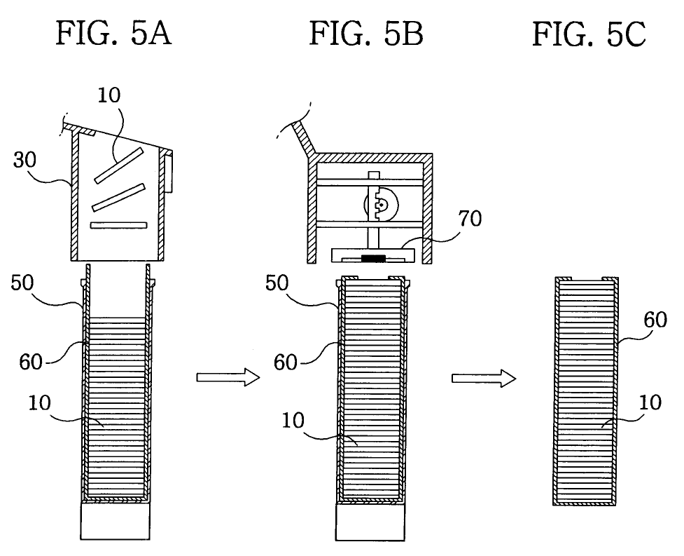

A coin sorting process of the above-described coin sorting apparatus will now be described with reference to FIG. 5A, 5B, 5C.

First, the casing tube 50 is inserted through the tube insert hole 22 of the main body 20 so that it can be stably seated on the transport unit 40. Accordingly, The casing tube 50 is transported by the transport unit 40. During the transportation, coins 10 that have been sorted by the coin sorting unit 30 are dropped and stacked in a coin tube 60 placed within the casing tube 50.

When a predetermined number of coins 10 are received in the coin tube 60, the coin sorting unit 30 stops dropping coins 10. Then, the transport unit 40 transports again the casing tube 5C) so that it is located under a pressing unit 70. When the casing tube 50 is located under the pressing unit 70, the pressing unit 70 moves down to press and bend inwardly an open top portion of the coin tube 60 that protrudes from the casing tube 50.

After that, the casing tube 50 is separated from the transport unit 40 and the top-bent coin tube 60 is also separated from the casing tube 50. After the separation of the coin tube 60, the casing tube 50 is inserted again into the main body 20 through the tube insert hole 22.

According to the present invention, sorting and firmly packaging processes are performed successively by the coin sorting unit 30 and the pressing unit 70 of the coin sorting apparatus. Accordingly, it is possible to improve functionality and usability of the coin sorting apparatus.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A coin sorting apparatus comprising:
a main body;
a coin sorting unit disposed in an upper portion of the main body to sort coins by type and drops the sorted coins;
a transport unit disposed in a lower portion of the main body;
a casing tube transported by the transport unit;
a coin tube formed of transparent plastic, the coin tube being placed within the casing tube, and a top portion of the coin tube protruding from the casing tube and being open so that coins dropped from the coin sorting unit are received and stacked in the coin tube; and
a pressing unit disposed in a front portion of the main body to move up and down so as to press and bend inwardly a top portion of the coin tube in which coins are received and stacked.

2. The coin sorting apparatus according to claim 1, wherein the pressing unit comprises:
a driving part;
a moving part coupled to the driving part to be moved up and down by the driving part; and
a pressing part disposed under the moving part to thermally press and bend an open top portion of the coin tube as the moving part moves down.

3. The coin sorting apparatus according to claim 2, wherein the driving part comprises:
a motor;
a pinion rotated by the motor; and
a rack engaged with the pinion to move up and down through the rotation of the pinion.

4. The coin sorting apparatus according to claim 1, wherein the coin sorting unit comprises a first sensor for detecting the number of coins dropped into the coin tube, and the pressing unit comprises a second sensor for detecting a received state of the coins received and stacked in the coin tube.
